(19) United States
(12) Patent Application Publication
(10) Pub. No.: US 2026/0346169 A1
(43) Pub. Date: Nov. 5, 2026

(54) WATER FILTER ASSEMBLY

(71) Applicant: Seunghu CHI, Seoul (KR)

(72) Inventor: Seunghu CHI, Seoul (KR)

(21) Appl. No.: 19/660,476

(22) Filed: Apr. 28, 2026

(30) Foreign Application Priority Data
Apr. 30, 2025 (KR) 10-2025-0057657

(51) Int. Cl. B01D 29/58; B01D 29/90

(52) U.S. Cl. CPC B01D 29/58; B01D 29/902

(57) ABSTRACT

A water filter assembly includes a first filter member including a first filter layer and a plurality of first guide members, a second filter member including a second filter layer and a plurality of second guide members, and a third filter member including a third filter layer and a plurality of third guide members. The plurality of second guide members are fitted into the plurality of first guide members and the plurality of third guide members are fitted into the plurality of second guide members, such that the first filter member, the second filter member, and the third filter member are coupled and assembled with one another.

### CROSS-REFERENCE TO RELATED APPLICATION

This application claims priority to and the benefit of Korean Patent Application No. 10-2025-0057657 filed in the Korean Intellectual Property Office on Apr. 30, 2025, the entire contents of which are incorporated herein by reference.

### BACKGROUND

### 1. Field

The present disclosure relates to a water filter assembly.

### 2. Description of the Related Art

In Africa and other regions experiencing water shortage problems, many problems occur due to using dirty water without filters.

These problems are disclosed in https://innoafrica.org/how-the-lack-of-clean-water-impacts-children/, and https://www.waterjournal.co.kr/news/articleView.html?idxno=66182.

Many filters for filtering dirty water have been developed. However, most filters are intended for filtering water from which visible contaminants like mud have already been firstly removed to make it potable, and they have a complex structure and high manufacturing cost.

### SUMMARY

The present disclosure attempts to provide a water filter assembly that may remove relatively large contaminant particles that are visible, has high portability, may be used with water bottles of various sizes, and has an uncomplicated structure resulting in a low manufacturing cost, thus allowing for easy supply to many users.

However, objects which embodiments attempt to achieve are not limited to the above-mentioned object, and can be variously expanded without departing from the technical spirit and scope of the embodiments.

According to an aspect of the present disclosure, a water filter assembly may include a first filter member including a first filter layer and a plurality of first guide members, a second filter member including a second filter layer and a plurality of second guide members, and a third filter member including a third filter layer and a plurality of third guide members. The plurality of second guide members may be fitted into the plurality of first guide members and the plurality of third guide members may be fitted into the plurality of second guide members, such that the first filter member, the second filter member, and the third filter member may be coupled and assembled with one another.

The first filter layer may be between the plurality of first guide members, the second filter layer may be between the plurality of second guide members, and the third filter layer may be between the plurality of third guide members.

The first filter layer may have a plurality of first holes, the second filter layer may have a plurality of second holes, the third filter layer may have a plurality of third holes. The plurality of first holes, the plurality of second holes, and the plurality of third holes may have different sizes.

The second filter member may be on the third filter member, the first filter member may be on the second filter member, a size of the plurality of first holes may be larger than a size of the plurality of second holes, and the size of the plurality of second holes may be larger than a size of the plurality of third holes.

The plurality of first guide members may be inclined to form a first angle with the first filter layer, the plurality of second guide members may be inclined to form the first angle with the second filter layer, the plurality of third guide members may be inclined to form the first angle with the third filter layer, and the first angle may be an acute angle.

The plurality of first guide members, the plurality of second guide members, and the plurality of third guide members may define a plurality of filtration paths having different sizes

Widths of the plurality of filtration paths may be decreasing from the first filter member toward the third filter member.

The plurality of first guide members may be protruding upward and downward from the first filter layer, the plurality of second guide members may be protruding upward and downward from the second filter layer, and the plurality of third guide members may be protruding upward and downward from the third filter layer.

The plurality of first guide members may have a circular planar shape, the plurality of second guide members may have a circular planar shape, and the plurality of third guide members may have a circular planar shape.

The first filter member, the second filter member, and the third filter member may have circular planar shapes.

Widths of the plurality of first guide members may be different from widths of the plurality of second guide members, and the widths of the plurality of second guide members may be different from widths of the plurality of third guide members

According to embodiments, it is possible to provide a water filter assembly that may remove relatively large contaminant particles that are visible, has high portability, may be used with water bottles of various sizes, and has an uncomplicated structure resulting in a low manufacturing cost, thus allowing for easy supply to many users.

However, the effects of the embodiments are not limited to the above-described effects, and it is apparent that they can be variously expanded without departing from the spirit and scope of this disclosure.

### BRIEF DESCRIPTION OF THE DRAWINGS

FIG. 1 is a perspective view of a water filter assembly according to an embodiment.

FIG. 2 is a cross-sectional view of the water filter assembly shown in FIG. 1.

FIG. 3 is an exploded view of a water filter assembly shown in FIG. 2.

FIG. 4 is a plan view showing a portion of a water filter assembly according to an embodiment.

FIG. 5 is a plan view showing a portion of a water filter assembly according to an embodiment.

FIG. 6 is a plan view showing a portion of a water filter assembly according to an embodiment.

FIG. 7 conceptually illustrates filtering using a water filter assembly according to an embodiment.

FIG. 8 conceptually illustrates filtering using a water filter assembly according to an embodiment.

FIG. 9 conceptually illustrates filtering using a water filter assembly according to an embodiment.

FIG. 10 conceptually illustrates filtering using a water filter assembly according to an embodiment.

FIG. 11 conceptually illustrates filtering using a water filter assembly according to an embodiment.

FIG. 12 conceptually illustrates filtering using a water filter assembly according to an embodiment.

FIG. 13 conceptually illustrates filtering using a water filter assembly according to an embodiment.

FIG. 14 conceptually illustrates filtering using a water filter assembly according to an embodiment.

### DETAILED DESCRIPTION

In the following detailed description, only certain embodiments of the present disclosure have been shown and described, simply by way of illustration. This disclosure can be variously implemented and is not limited to the following embodiments.

The drawings and description are to be regarded as illustrative in nature and not restrictive. Like reference numerals designate like elements throughout the specification.

Further, the accompanying drawings are provided for helping to easily understand embodiments disclosed in the present specification, and the technical spirit disclosed in the present specification is not limited by the accompanying drawings, and it will be appreciated that this disclosure includes all of the modifications, equivalent matters, and substitutes included in the spirit and the technical scope of this disclosure.

In addition, the size and thickness of each configuration shown in the drawings are arbitrarily shown for understanding and ease of description, but this disclosure is not limited thereto. In the drawings, the thickness of layers, films, panels, regions, etc., are exaggerated for clarity. Further, in the drawings, for understanding and ease of description, the thickness of some layers and areas is exaggerated.

Further, it will be understood that when an element such as a layer, film, region, or substrate is referred to as being “on” another element, it can be directly on the other element or intervening elements may also be present. In contrast, when an element is referred to as being “directly on” another element, there are no intervening elements present. Further, when an element is “on” a reference portion, the element is located above or below the reference portion, and it does not necessarily mean that the element is located “above” or “on” in a direction opposite to gravity.

In addition, in the entire specification, unless explicitly described to the contrary, the word “comprise”, and variations such as “comprises” or “comprising”, will be understood to imply the inclusion of stated elements but not the exclusion of any other elements.

Further, in the entire specification, when it is referred to as “on a plane”, it means when a target part is viewed from above, and when it is referred to as “on a cross-section”, it means when the cross-section obtained by cutting a target part vertically is viewed from the side.

Further, throughout the specification, when it is referred to as “connected”, this does not only mean that two or more constituent elements are directly connected, but may mean that two or more constituent elements are indirectly connected through another constituent element, are physically connected, electrically connected, or are integrated even though two or more constituent elements are referred as different names depending on a location and a function.

Hereinafter, various embodiments and modifications will be described in detail with reference to the drawings.

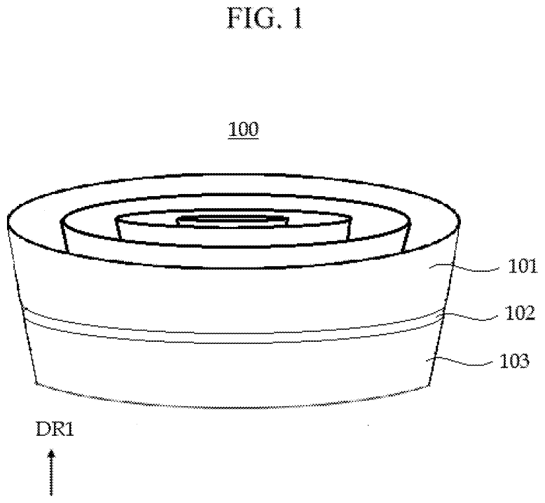

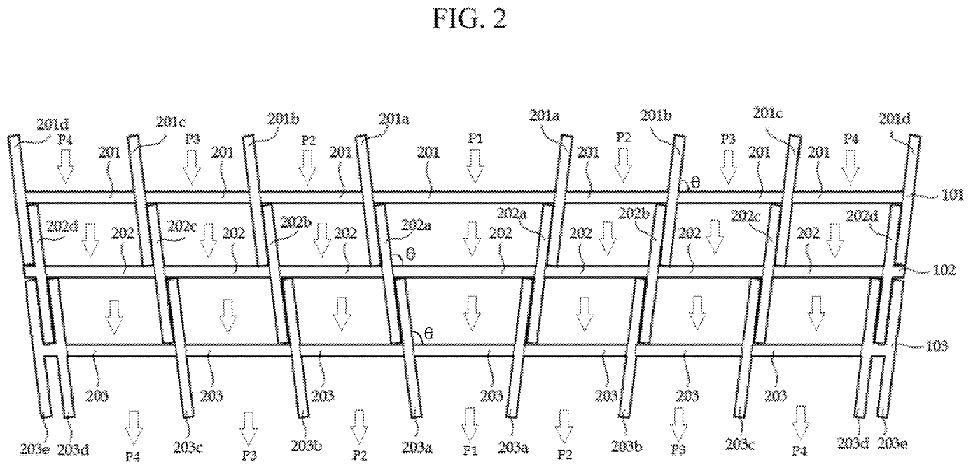

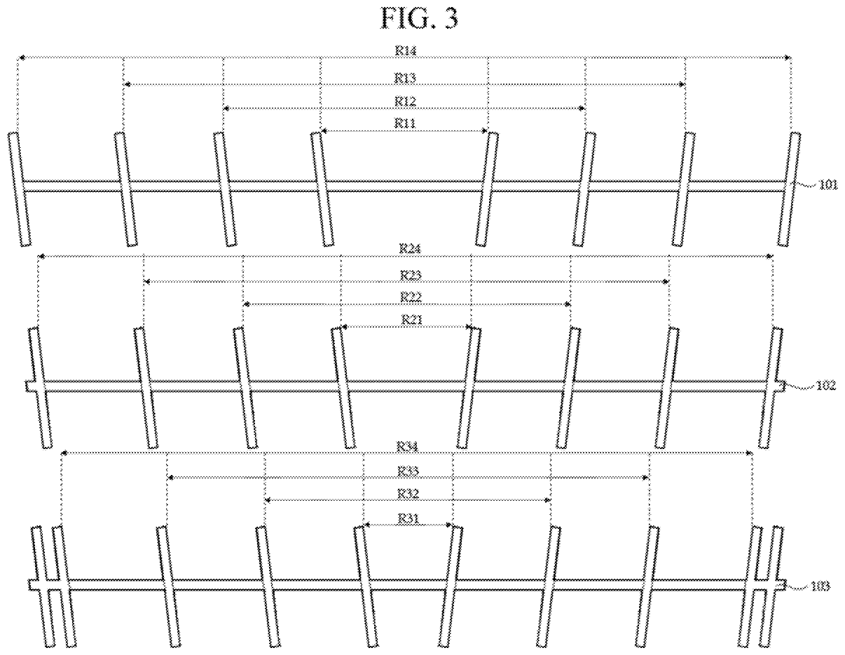

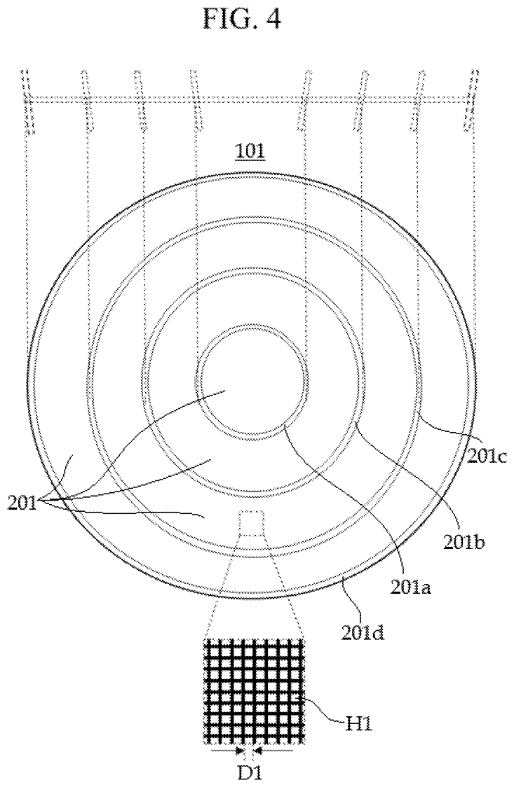

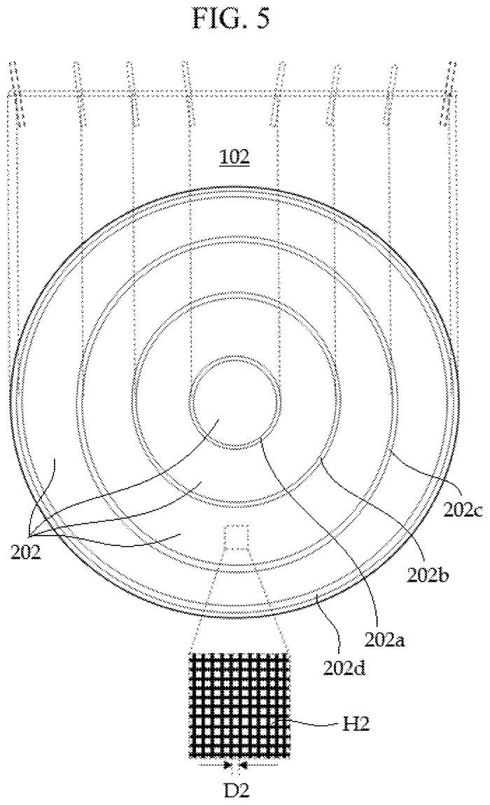

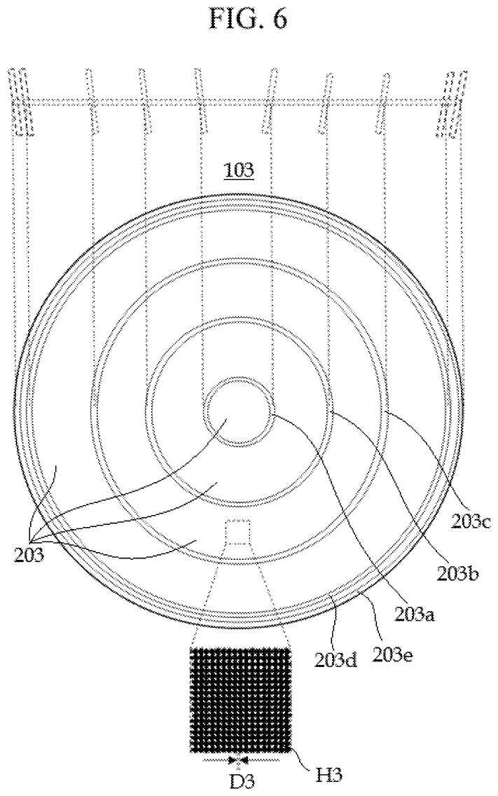

With reference to FIGS. 1 to 7, a water filter assembly 100 according to an embodiment will be described. FIG. 1 is a perspective view of a water filter assembly according to an embodiment, FIG. 2 is a cross-sectional view of the water filter assembly shown in FIG. 1, FIG. 3 is an exploded view of a water filter assembly shown in FIG. 2, and FIGS. 4 to 6 are plan views showing a portion of a water filter assembly according to an embodiment.

Referring to FIGS. 1 to 6, a water filter assembly 100 according to an embodiment may include a plurality of filter members 101, 102, and 103. According to the illustrated embodiment, the water filter assembly 100 according to an embodiment includes three filter members 101, 102, and 103, but the embodiment is not limited thereto, and the number of filter members may be variable as needed.

The plurality of filter members 101, 102, and 103 may be stacked along a first direction DR1 and may be separated from each other. The first filter member 101, the second filter member 102, and the third filter member 103 may have the same planar shapes as each other. In the illustrated embodiment, the first filter member 101, the second filter member 102, and the third filter member 103 are shown as having a circular planar shape, but the embodiment is not limited thereto, and the first filter member 101, the second filter member 102, and the third filter member 103 may have various planar shapes. For example, the edge of the first filter member 101, the edge of the second filter member 102, and the edge of the third filter member 103 may have rectangular planar shapes.

The first filter member 101 may include a first filter layer 201 and a plurality of first guide members 201a, 201b, 201c, and 201d, the second filter member 102 may include a second filter layer 202 and a plurality of second guide members 202a, 202b, 202c, and 202d, and the third filter member 103 may include a third filter layer 203 and a plurality of third guide members 203a, 203b, 203c, 203d, and 203e.

As the structures of the first filter member 101, the second filter member 102, and the third filter member 103 of the water filter assembly 100 are simple, the manufacturing cost of the water filter assembly 100 may be reduced.

The plurality of first guide members 201a, 201b, 201c, and 201d may have the same planar shapes as one another, the plurality of second guide members 202a, 202b, 202c, and 202d may have the same planar shapes as one another, and the plurality of third guide members 203a, 203b, 203c, 203d, and 203e may have the same planar shapes as one another.

The plurality of first guide members 201a, 201b, 201c, and 201d may have the same planar shapes as the edge of the first filter member 101, the plurality of second guide members 202a, 202b, 202c, and 202d may have the same planar shapes as the edge of the second filter member 102, and the plurality of third guide members 203a, 203b, 203c, 203d, and 203e may have the same planar s as the edge of the third filter member 103. However, the embodiment is not limited thereto, and the plurality of first guide members 201a, 201b, 201c, and 201d may have different planar shapes from the edge of the first filter member 101, the plurality of second guide members 202a, 202b, 202c, and 202d may have different planar shapes from the edge of the second filter member 102, and the plurality of third guide members 203a, 203b, 203c, 203d, and 203e may have different planar shapes from the edge of the third filter member 103. For example, each of the edge of the first filter member 101, the edge of the second filter member 102, and the edge of the third filter member 103 may have a rectangular planar shape, and the plurality of first guide members 201a, 201b, 201c, and 201d, the plurality of second guide members 202a, 202b, 202c, and 202d, and the plurality of third guide members 203a, 203b, 203c, 203d, and 203e may have circular planar shapes.

The first filter layer 201 may be positioned between the first sub-guide member 201a, the second sub-guide member 201b, the third sub-guide member 201c and the fourth sub-guide member 201d of the first filter member 101. The first sub-guide member 201a, the second sub-guide member 201b, the third sub-guide member 201c, and the fourth sub-guide member 201d of the first filter member 101 may be protruding upward and downward from the first filter layer 201.

The second filter layer 202 may be positioned between the first sub-guide member 202a, the second sub-guide member 202b, the third sub-guide member 202c, and the fourth sub-guide member 202d of the second filter member 102. The first sub-guide member 202a, the second sub-guide member 202b, the third sub-guide member 202c, and the fourth sub-guide member 202d of the second filter member 102 may be protruding upward and downward from the second filter layer 202.

The third filter layer 203 may be positioned between the first sub-guide member 203a, the second sub-guide member 203b, the third sub-guide member 203c, and the fourth sub-guide member 203d of the third filter member 103. The first sub-guide member 203a, the second sub-guide member 203b, the third sub-guide member 203c, the fourth sub-guide member 203d, and the fifth sub-guide member 203e of the third filter member 103 may be protruding upward and downward from the third filter layer 203.

The first sub-guide member 201a, the second sub-guide member 201b, the third sub-guide member 201c, and the fourth sub-guide member 201d of the plurality of first guide members 201a, 201b, 201c, and 201d may be positioned in order from the central portion of the first filter member 101 to the edge.

The plurality of first guide members 201a, 201b, 201c, and 201d may be inclined to form a first angle θ with the surface of the first filter layer 201 of the first filter member 101. The first angle θ may be an acute angle.

The first sub-guide member 202a, the second sub-guide member 202b, the third sub-guide member 202c, and the fourth sub-guide member 202d of the plurality of second guide members 202a, 202b, 202c, and 202d may be positioned in order from the central portion of the second filter member 102 to the edge.

The plurality of second guide members 202a, 202b, 202c, and 202d may be inclined to form the first angle θ with the surface of the second filter layer 202 of the second filter member 102.

The first sub-guide member 203a, the second sub-guide member 203b, the third sub-guide member 203c, the fourth sub-guide member 203d, and the fifth sub-guide member 203e of the plurality of third guide members 203a, 203b, 203c, 203d, and 203e may be positioned in order from the central portion of the third filter member 103 to the edge.

The plurality of third guide members 203a, 203b, 203c, 203d, and 203e may be inclined to form the first angle θ with the surface of the third filter layer 203 of the third filter member 103.

A diameter R11 of the first sub-guide member 201a of the first filter member 101 may be larger than a diameter R21 of the first sub-guide member 202a of the second filter member 102, and the diameter R21 of the first sub-guide member 202a of the second filter member 102 may be larger than a diameter R31 of the first sub-guide member 203a of the third filter member 103.

A diameter R12 of the second sub-guide member 201b of the first filter member 101 may be larger than a diameter R22 of the second sub-guide member 202b of the second filter member 102, and the diameter R22 of the second sub-guide member 202b of the second filter member 102 may be larger than a diameter R32 of the second sub-guide member 203b of the third filter member 103.

A diameter R13 of the third sub-guide member 201c of the first filter member 101 may be larger than a diameter R23 of the third sub-guide member 202c of the second filter member 102, and the diameter R23 of the third sub-guide member 202c of the second filter member 102 may be larger than a diameter R33 of the third sub-guide member 203c of the third filter member 103.

A diameter R14 of the fourth sub-guide member 201d of the first filter member 101 may be larger than a diameter R24 of the fourth sub-guide member 202d of the second filter member 102. The diameter R24 of the fourth sub-guide member 202d of the second filter member 102 may be larger than a diameter R34 of the fourth sub-guide member of the third filter member 103 and may be smaller than a diameter R35 of the fifth sub-guide member 203e of the third filter member 103.

When the first filter member 101, the second filter member 102, and the third filter member 103 are assembled, the first sub-guide member 202a of the second filter member 102 is positioned within the first sub-guide member 201a of the first filter member 101 so that an upper portion of the first sub-guide member 202a of the second filter member 102 may be fitted inside a lower portion of the first sub-guide member 201a of the first filter member 101 to be fixed without moving laterally.

When the first filter member 101, the second filter member 102, and the third filter member 103 are assembled, the second sub-guide member 202b of the second filter member 102 is positioned within the second sub-guide member 201b of the first filter member 101 so that an upper portion of the second sub-guide member 202b of the second filter member 102 may be fitted inside a lower portion of the second sub-guide member 201b of the first filter member 101 to be fixed without moving laterally.

When the first filter member 101, the second filter member 102, and the third filter member 103 are assembled, the third sub-guide member 202c of the second filter member 102 is positioned within the third sub-guide member 201c of the first filter member 101 so that an upper portion of the third sub-guide member 202c of the second filter member 102 may be fitted inside a lower portion of the third sub-guide member 201c of the first filter member 101 to be fixed without moving laterally.

Similarly, when the first filter member 101, the second filter member 102, and the third filter member 103 are assembled, the fourth sub-guide member 202d of the second filter member 102 is positioned within the fourth sub-guide member 201d of the first filter member 101 so that an upper portion of the fourth sub-guide member 202d of the second filter member 102 may be fitted inside a lower portion of the fourth sub-guide member 201d of the first filter member 101 to be fixed without moving laterally.

When the first filter member 101, the second filter member 102, and the third filter member 103 are assembled, an upper portion of the fourth sub-guide member 203d of the third filter member 103 may be fitted and fixed inside a lower portion of the fourth sub-guide member 202d of the second filter member 102, and the fourth sub-guide member 202d of the second filter member 102 may be fitted between the fourth sub-guide member 203d and the fifth sub-guide member 203e of the third filter member 103 to be fixed without moving laterally.

The first sub-guide member 201a of the first filter member 101, the first sub-guide member 202a of the second filter member 102, and the first sub-guide member 203a of the third filter member 103 may be fitted to be positioned in order from the outside to the inside to form a first filtration path P1. A width of the first filtration path P1 may gradually decrease from the top to the bottom of the water filter assembly 100.

The second sub-guide member 201b of the first filter member 101, the second sub-guide member 202b of the second filter member 102, and the second sub-guide member 203b of the third filter member 103 may be fitted to be positioned in order from the outside to the inside to form a second filtration path P2. A width of the second filtration path P2 may gradually decrease from the top to the bottom of the water filter assembly 100.

The third sub-guide member 201c of the first filter member 101, the third sub-guide member 202c of the second filter member 102, and the third sub-guide member 203c of the third filter member 103 may be fitted to be positioned in order from the outside to the inside to form a third filtration path P3. A width of the third filtration path P3 may gradually decrease from the top to the bottom of the water filter assembly 100.

The fourth sub-guide member 201d of the first filter member 101, the fourth sub-guide member 202d of the second filter member 102, and the fourth sub-guide member 203d and the fifth sub-guide member 203e of the third filter member 103 may form a fourth filtration path P4. A width of the fourth filtration path P4 may gradually decrease from the top to the bottom of the water filter assembly 100.

The width of the second filtration path P2 may be larger than the width of the first filtration path P1, the width of the third filtration path P3 may be larger than the width of the second filtration path P2, and the width of the fourth filtration path P4 may be larger than the width of the third filtration path P3.

The first filtration path P1, the second filtration path P2, the third filtration path P3, and the fourth filtration path P4 may be water flow paths that allow water supplied to the water filter assembly 100 to be filtered and the filtered water to be received in a container positioned below the water filter assembly 100.

The first filter layer 201 of the first filter member 101 may have a plurality of first holes H1, the second filter layer 202 of the second filter member 102 may have a plurality of second holes H2, and the third filter layer 203 of the third filter member 103 may have a plurality of third holes H3.

The first filter layer 201 of the first filter member 101, the second filter layer 202 of the second filter member 102, and the third filter layer 203 of the third filter member 103 may include a metal such as stainless steel that may prevent the occurrence of rust. The first filter layer 201 of the first filter member 101, the second filter layer 202 of the second filter member 102, and the third filter layer 203 of the third filter member 103 may include polypropylene (PP) or cotton. However, the embodiment is not limited thereto, and the first filter layer 201 of the first filter member 101, the second filter layer 202 of the second filter member 102, and the third filter layer 203 of the third filter member 103 may include various materials that may have holes.

A size D1 of each of the plurality of first holes H1 of the first filter layer 201 may be larger than a size D2 of each of the plurality of second holes H2 of the second filter layer 202, and the size D2 of each of the plurality of second holes H2 of the second filter layer 202 may be larger than a size D3 of each of the plurality of third holes H3 of the third filter layer 203.

For example, the size D1 of each of the plurality of first holes H1 of the first filter layer 201 may be 100 μm to 500 μm, and the first filter layer 201 may filter large contaminant particles such as coarse sand, leaves, and large soil grains.

For example, the size D2 of each of the plurality of second holes H2 of the second filter layer 202 may be 10 μm to 50 μm, and the second filter layer 202 may filter medium contaminant particles such as fine sand, silt, and rust residue.

For example, the size D3 of each of the plurality of third holes H3 of the third filter layer 203 may be 1 μm to 5 μm, and the third filter layer 203 may filter small contaminant particles such as fine mud particles and some bacteria.

However, the embodiment is not limited thereto, and the size D1 of each of the plurality of first holes H1 of the first filter layer 201, the size D2 of each of the plurality of second holes H2 of the second filter layer 202, and the size D3 of each of the plurality of third holes H3 of the third filter layer 203 may be variously changed as needed.

When water to be filtered is introduced from the top of the water filter assembly 100, it may be filtered as it moves sequentially through the first filter layer 201, the second filter layer 202, and the third filter layer 203, and after large contaminant particles are firstly filtered in the first filter layer 201, the firstly filtered water undergoes secondly filtering of medium contaminant particles in the second filter layer 202, and then the firstly and secondly filtered water may undergo thirdly filtering of small contaminant particles in the third filter layer 203.

By sequentially filtering large contaminant particles, medium contaminant particles, and small contaminant particles from the contaminated water to be filtered, it is possible to prevent the filtering efficiency from decreasing due to the contaminant particles filtered by each filter layer clogging the holes H1, H2, and H3 of each filter layer compared to when filtering contaminated water to be filtered with a single filter layer.

When water to be filtered is introduced from the top of the water filter assembly 100, it may be filtered as it moves sequentially through the first filter layer 201, the second filter layer 202, and the third filter layer 203 along the first filtration path P1 as needed, or filtered as it moves sequentially through the first filter layer 201, the second filter layer 202, and the third filter layer 203 along the first filtration path P1 and the second filtration path P2, or filtered as it moves sequentially through the first filter layer 201, the second filter layer 202, and the third filter layer 203 along the first filtration path P1, the second filtration path P2, and the third filtration path P3, or filtered as it moves sequentially through the first filter layer 201, the second filter layer 202, and the third filter layer 203 along the first filtration path P1, the second filtration path P2, the third filtration path P3, and the fourth filtration path P4.

The water filter assembly 100 has various water filtration paths, such as a path including the first filtration path P1, a path including the first filtration path P1 and the second filtration path P2, a path including the first filtration path P1 to the third filtration path P3, or a path including the first filtration path P1 to the fourth filtration path P4, thereby performing water filtration suitable for various containers having various sizes.

The sub-guide members may form the filtration paths allowing water to be filtered to flow through the filtration paths and preventing leakage to the outside, thereby preventing waste.

The first filter member 101, the second filter member 102, and the third filter member 103 of the water filter assembly 100 may be separated from one another, so that if filtered contaminant particles accumulate on the first filter member 101, the second filter member 102, and the third filter member 103 and clog the holes H1, H2, and H3 of each filter layer, the contaminant particles accumulated on the first filter member 101, the second filter member 102, and the third filter member 103 may be easily removed. Even if the first filter member 101, the second filter member 102, and the third filter member 103 are contaminated, they may be separated from one another, the contaminant particles may be removed, and then reassembled for use in water filtration, so they may be used permanently without replacing parts of the water filter assembly 100. Therefore, the increase in cost of the water filter assembly 100 may be reduced.

As described above, the first filter member 101, the second filter member 102, and the third filter member 103 of the water filter assembly 100 may be assembled by the plurality of first guide members 201a, 201b, 201c, and 201d, the plurality of second guide members 202a, 202b, 202c, and 202d, and the plurality of third guide members 203a, 203b, 203c, 203d, and 203e being fitted to each other without an additional coupling member, so the structure may be simple. Therefore, the manufacturing process of the water filter assembly 100 may be simplified, and the manufacturing cost may be reduced.

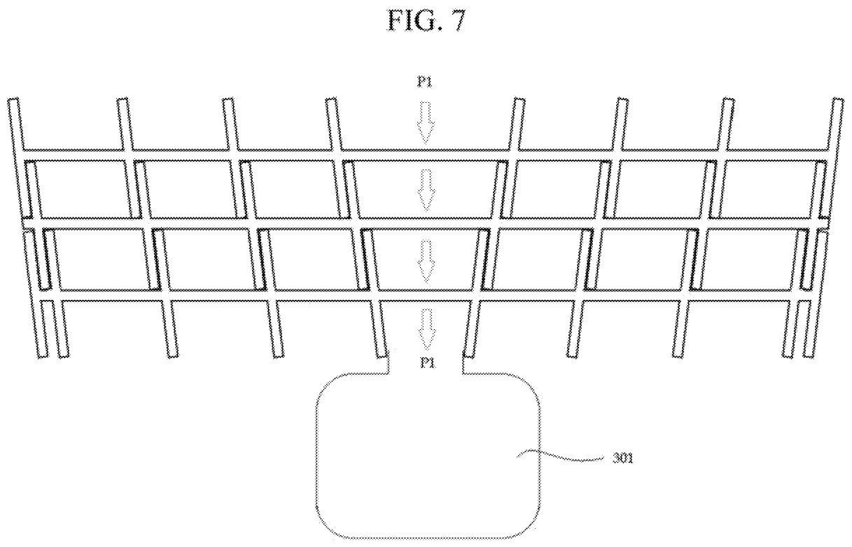

With reference to FIGS. 7 to 14 along with FIGS. 1 to 6, various water filtration paths using the water filter assembly 100 will be described. FIGS. 7 to 10 conceptually illustrate filtering using a water filter assembly according to an embodiment.

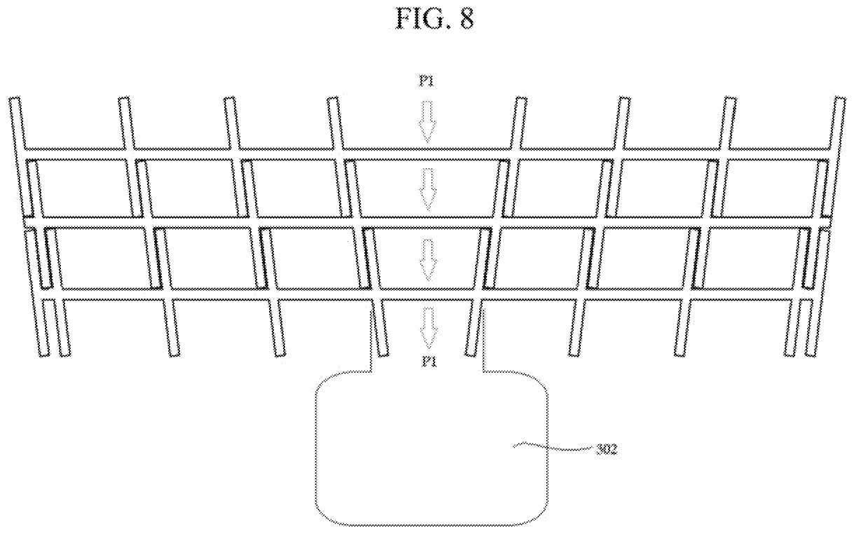

Referring to FIG. 7 and FIG. 8, when water filtration is performed using a first container 301 that may be positioned inside the edge of the bottom of the first sub-guide member 203a of the third filter member 103 positioned at the bottom-most among the sub-guide members 201a, 202a, and 203a forming the first filtration path P1, or a second container 302 having a diameter into which the edge of the bottom of the first sub-guide member 203a may be inserted, the water introduced into the water filter assembly 100 is filtered through the first filter member 101, the second filter member 102, and the third filter member 103 via the first filtration path P1 and may be received in the first container 301 or the second container 302.

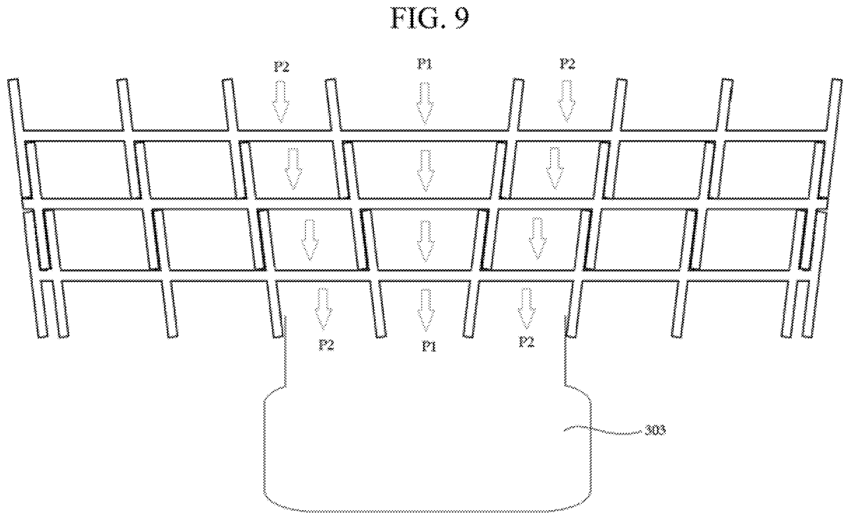

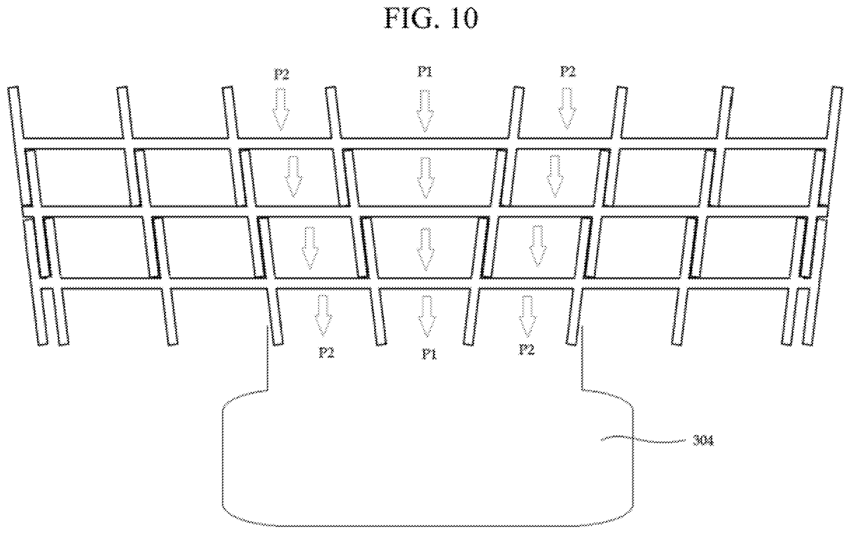

Referring to FIG. 9 and FIG. 10, when water filtration is performed using a third container 303 that may be positioned inside the edge of the bottom of the second sub-guide member 203b of the third filter member 103 positioned at the bottom-most among the sub-guide members 201b, 202b, and 203b forming the second filtration path P2, or a fourth container 304 having a diameter into which the edge of the bottom of the second sub-guide member 203b may be inserted, the water introduced into the water filter assembly 100 is filtered through the first filter member 101, the second filter member 102, and the third filter member 103 via the first filtration path P1 and the second filtration path P2 and may be received in the third container 303 or the fourth container 304.

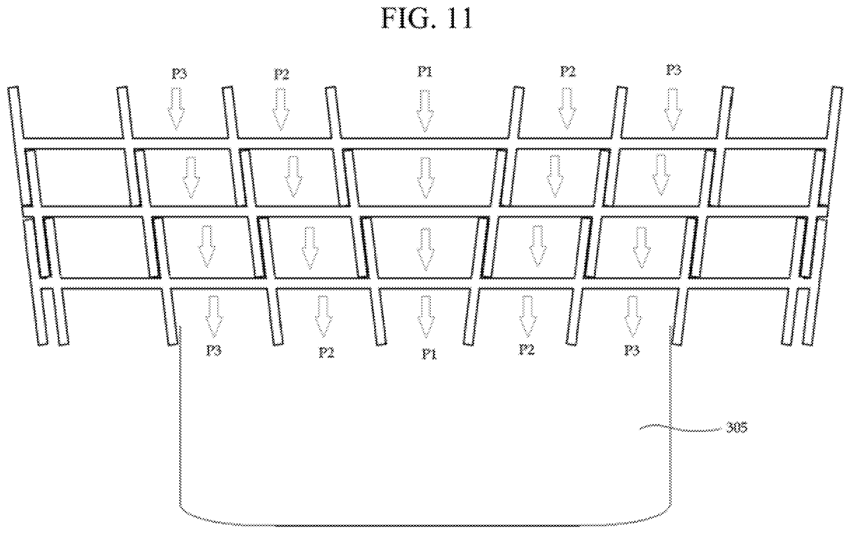

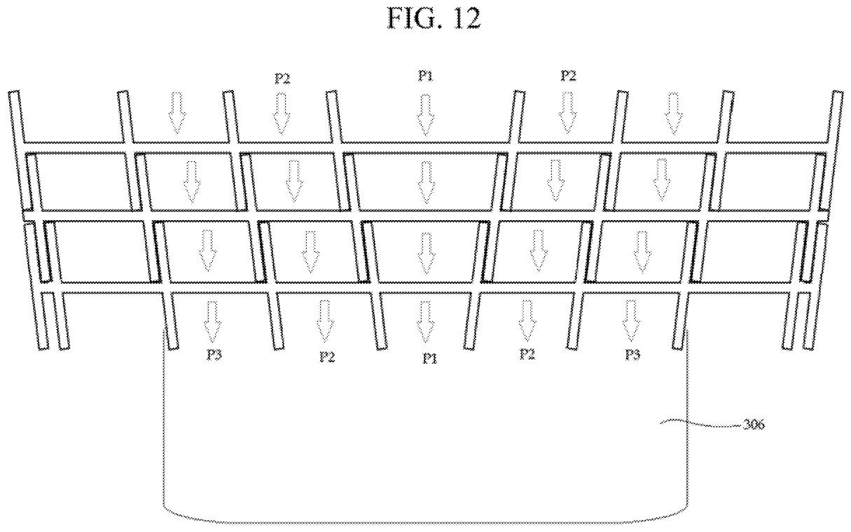

Referring to FIG. 11 and FIG. 12, when water filtration is performed using a fifth container 305 that may be positioned inside the edge of the bottom of the third sub-guide member 203c of the third filter member 103 positioned at the bottom-most among the sub-guide members 201c, 202c, and 203c forming the third filtration path P3, or a sixth container 306 having a diameter into which the edge of the bottom of the third sub-guide member 203c may be inserted, the water introduced into the water filter assembly 100 is filtered through the first filter member 101, the second filter member 102, and the third filter member 103 via the first filtration path P1 and the second filtration path P2 as well as the third filtration path P3 and may be received in the fifth container 305 or the sixth container 306.

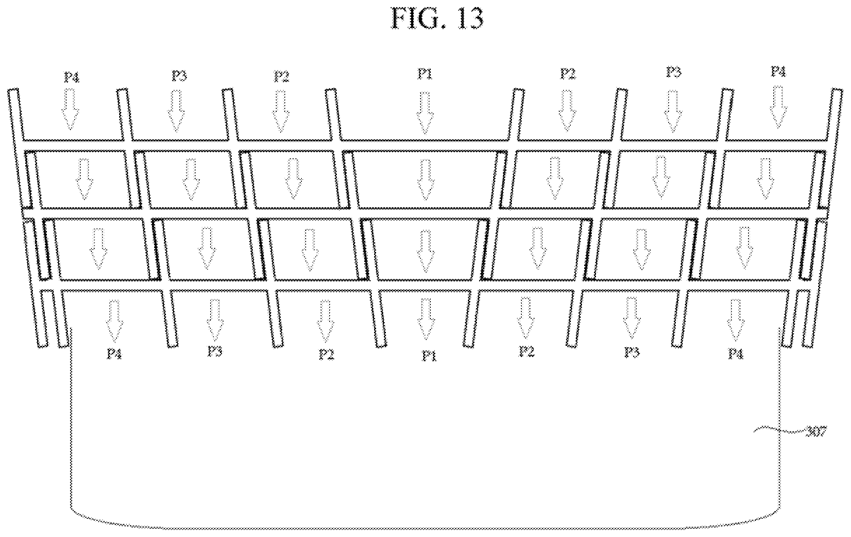

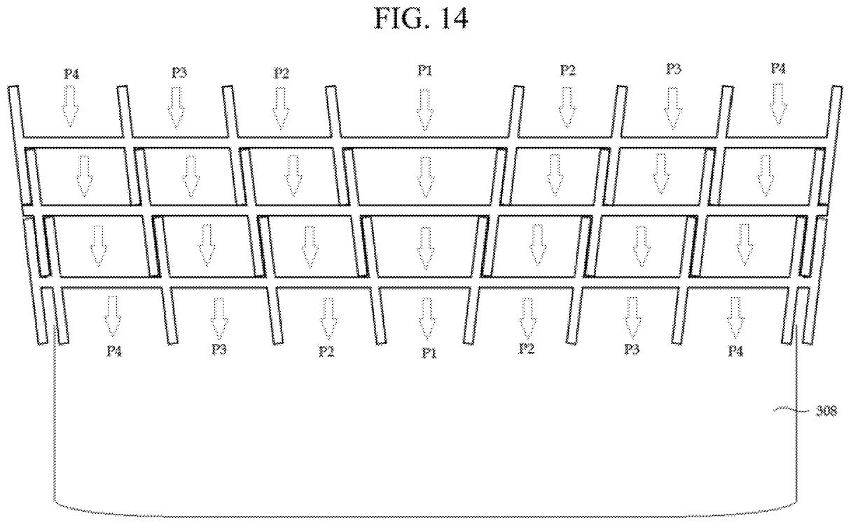

Referring to FIG. 13 and FIG. 14, when water filtration is performed using a seventh container 307 that may be positioned inside the edge of the bottom of the fourth sub-guide member 203d and the fifth sub-guide member 203e of the third filter member 103 positioned at the bottom-most among the sub-guide members 201d, 202d, 203d, 203e forming the fourth filtration path P4, or an eighth container 308 having a diameter into which the edge of the bottom of the fifth sub-guide member 203e may be inserted, the water introduced into the water filter assembly 100 is filtered through the first filter member 101, the second filter member 102, and the third filter member 103 via the first filtration path P1, the second filtration path P2, and the third filtration path P3 as well as the fourth filtration path P4 and may be received in the seventh container 307 or the eighth container 308.

According to the embodiment, the guide members of the water filter assembly 100 may form various water filtration paths such as the first filtration path P1, the second filtration path P2, the third filtration path P3, and the fourth filtration path P4. Therefore, water filtration may be performed using all types of water bottles of various sizes having various size inlets. Instead of using different filter assemblies depending on the size of the container, water filtration may be performed using one filter assembly regardless of the size of the container, thereby increasing the efficiency of the water filter assembly.

While this disclosure has been described in connection with what is presently considered to be practical embodiments, it is to be understood that this disclosure is not limited to the disclosed embodiments. On the contrary, it is intended to cover various modifications and equivalent arrangements included within the spirit and scope of the appended claims.

What is claimed is:

1. A water filter assembly comprising:
a first filter member including a first filter layer and a plurality of first guide members,
a second filter member including a second filter layer and a plurality of second guide members, and
a third filter member including a third filter layer and a plurality of third guide members,
wherein the plurality of second guide members are fitted into the plurality of first guide members and the plurality of third guide members are fitted into the plurality of second guide members, such that the first filter member, the second filter member, and the third filter member are coupled and assembled with one another.

2. The water filter assembly of claim 1, wherein
the first filter layer is between the plurality of first guide members,
the second filter layer is between the plurality of second guide members, and
the third filter layer is between the plurality of third guide members.

3. The water filter assembly of claim 2, wherein
the first filter layer has a plurality of first holes,
the second filter layer has a plurality of second holes,
the third filter layer has a plurality of third holes, and
the plurality of first holes, the plurality of second holes, and the plurality of third holes have different sizes.

4. The water filter assembly of claim 3, wherein
the second filter member is on the third filter member,
the first filter member is on the second filter member,
a size of each of the plurality of first holes is larger than a size of each of the plurality of second holes, and the size of each of the plurality of second holes is larger than a size of each of the plurality of third holes.

5. The water filter assembly of claim 3, wherein
the plurality of first guide members are inclined to form a first angle with the first filter layer,
the plurality of second guide members are inclined to form the first angle with the second filter layer,
the plurality of third guide members are inclined to form the first angle with the third filter layer, and
the first angle is an acute angle.

6. The water filter assembly of claim 5, wherein
the plurality of first guide members, the plurality of second guide members, and the plurality of third guide members define a plurality of filtration paths having different sizes.

7. The water filter assembly of claim 6, wherein
widths of the plurality of filtration paths are decreasing from the first filter member toward the third filter member.

8. The water filter assembly of claim 4, wherein
the plurality of first guide members are protruding upward and downward from the first filter layer,
the plurality of second guide members are protruding upward and downward from the second filter layer, and
the plurality of third guide members are protruding upward and downward from the third filter layer.

9. The water filter assembly of claim 1, wherein
the plurality of first guide members are inclined to form a first angle with the first filter layer,
the plurality of second guide members are inclined to form the first angle with the second filter layer,
the plurality of third guide members are inclined to form the first angle with the third filter layer, and
the first angle is an acute angle.

10. The water filter assembly of claim 9, wherein
the plurality of first guide members, the plurality of second guide members, and the plurality of third guide members define a plurality of filtration paths having different sizes.

11. The water filter assembly of claim 10, wherein
widths of the plurality of filtration paths are decreasing from the first filter member toward the third filter member.

12. The water filter assembly of claim 1, wherein
the plurality of first guide members are protruding upward and downward from the first filter layer,
the plurality of second guide members are protruding upward and downward from the second filter layer, and
the plurality of third guide members are protruding upward and downward from the third filter layer.

13. The water filter assembly of claim 1, wherein
the plurality of first guide members have a circular planar shape,
the plurality of second guide members have a circular planar shape, and
the plurality of third guide members have a circular planar shape.

14. The water filter assembly of claim 13, wherein
the first filter member, the second filter member, and the third filter member have circular planar shapes.

15. The water filter assembly of claim 13, wherein
widths of the plurality of first guide members are different from widths of the plurality of second guide members, and
the widths of the plurality of second guide members are different from widths of the plurality of third guide members.
